(19) United States
(12) Patent Application Publication
(10) Pub. No.: US 2002/0040928 A1
(43) Pub. Date: Apr. 11, 2002

(54) Luggage-to-passenger match verification device

(76) Inventors: Reza Jalili, Bronxville, NY (US); Sarkis Boghjalian, Sunnyside Queens, NY (US)

Correspondence Address: Reza Jalili, 1 Vincent Road #3-O, Bronxville, NY, 10708, US

(21) Appl. No.: 09/975,643

(22) Filed: Oct. 11, 2001

Related U.S. Application Data
(60) Provisional application No. 60/239,342, filed on Oct. 11, 2000.

(51) Int. Cl. G06F 17/60

(52) U.S. Cl. 235/385

(57) ABSTRACT

In order to control the taking of luggage from an airport baggage claim area, a hand-held electronic luggage match device is disclosed. The device reads barcode information attached to luggage and barcode information attached ticket stubs and automatically detects when a passenger has presented all the matching ticket stubs for retrieving the claimed luggage. When a passenger presents all the necessary stubs for all the luggage pieces claimed, a green light and a beep indicate proper verification. The event of luggage pick-up is then logged and time-stamped by the device for future reference.

### CROSS-REFERENCE TO RELATED APPLICATION

This application is based on and claims priority from U.S. Provisional Patent Application Serial No. 60/239,342 filed on Oct. 11, 2000.

### FIELD OF THE INVENTION

The present invention is directed generally to an electronic device for verification of ownership of packages and luggage.

### BACKGROUND OF THE INVENTION

When passengers at an airport go to the baggage claim area, they typically find many bags that look alike on a conveyor belt or circular collection area. There is generally no verification that a person taking a bag from the baggage claim area in fact is the owner of that bag. While loss due to theft or incorrect handling may be rare, many passengers still feel nervous upon arrival about whether their luggage will be there or not at the baggage claim area. There is undue anxiety often related to the fear that someone else will pickup one's luggage as there is often inadequate security in the baggage claim areas.

One reason for not having individuals guarding the baggage claim area to verify every picked up piece of luggage is that the verification process is time consuming. Each passenger has multiple pieces of luggage and manual verification would cause too much inconvenience to passengers. Furthermore, this verification service may be viewed as a cost with no other benefits to the airport facility or carriers providing the service.

A bar code tag is printed on a luggage tag and a duplicate of the tag is attached to a passenger's ticket envelope. The bar-coded luggage tag is used by luggage handling systems to route the luggage through a maze of conveyor belts from the check-in desk to the aircraft, and off the aircraft to the baggage claim area.

A guard sometimes is provided at the baggage claim area to ensure that passengers leave with the proper pieces of luggage.

Often passengers take the wrong luggage. Sometimes luggage is stolen. Sometimes passengers claim to have lost luggage when in fact such is not the case.

To date, much emphasis has been placed on ensuring that luggage checked in is safe and that each passenger checking luggage boards the aircraft. See the two patents referenced below.

U.S. Pat. No. 5,051,565 “Baggage and passenger matching method and system” writes in its abstract: “A system and method for matching all loaded baggage with passengers during aircraft boarding provides each passenger with a boarding pass and baggage tags, each having the same unique machine readable code imprinted thereon. A scanner and memory device at the boarding point scans and reads a passenger's pass and stores the code. A portable scanner and memory at the baggage loading point scans and reads each luggage tag and stores each code. The stored codes are delivered to the passenger loading gate prior to departure of the aircraft. A computer compares stored passenger codes with stored baggage codes. Lack of a stored loading pass code with a matching stored code of loaded baggage is indicated to permit inspection of such baggage prior to aircraft departure.”

U.S. Pat. No. 4,711,994 “Security system for correlating passengers and their baggage” writes in its abstract: “A method, and its associated system, for maintaining a close and accurate security surveillance of both the passengers and their baggage on a public conveyance, to insure that, before departure, baggage is not loaded aboard the conveyance without a prior, positive indication that the owner or the passenger has, in fact, been properly boarded.”

Various systems and methods have been disclosed which solve the problems of luggage routing from check-in to final destination and of luggage tracking. U.S. Pat. No. 4,531,312 identifies a problem with making sure a tag stays attached to a given piece of luggage.

U.S. Pat. No. 5,831,531 identifies the problem of detecting unauthorized opening of luggage.

U.S. Pat. Nos. 5,842,555 and 5,920,053 are devoted to security of luggage checked in.

U.S. Pat. No. 6,222,452 offers a better scanning solution and offers these words: “Traditional luggage identification systems have suffered from the drawbacks inherent in their simplicity. Printed hang tags require manual inspection by security personnel, an extremely time-consuming process. Even optical bar code identification systems require that airport or security personnel handle the tag of each piece of luggage in order to pass the bar-coded tag in the appropriate orientation past an optical reader. As a result, it is impracticable to optically “scan” an individual item of luggage more than once during a passenger's journey. Also, printed hang tags, even when supplemented with passenger identification programs, are vulnerable to fraud and mistake.

High cost has also hindered the development of viable electronic identification tags. An electronic hang tag ideally must be so inexpensive as to be a single-use device. An expensive transmitter must be reused on the luggage of multiple passengers on successive trips in order economically to recover the transmitter cost. Transmitter reuse thus becomes extremely undesirable due to the need to recover each device at the conclusion of a passenger's trip, re-distribute the device to a new point of origin for attachment to a second piece of luggage, etc.”

Prior art search tells us: “The world's first large-scale trial to identify airline luggage, using disposable “smart labels” to speed up luggage handling, reduce missing baggage and increase security, began this month. For the two month trial, British Airways has asked Philips Semiconductors to test its I.cndot.CODE smart label radio frequency identification (RFID) technology to identify 75,000 suitcases travelling with passengers from Munich, Germany and Manchester, UK to London's Heathrow airport.

Each “smart bag tag” contains an integrated circuit (IC), that can be programmed with detailed information such as the date and time the luggage is checked in, the weight, as well as a unique identification number and the passenger's destination.”

### SUMMARY OF THE INVENTION

It is an object of this invention to facilitate the verification of luggage pickup at an airport.

It is an object of this invention to provide a means for passengers to know that they are leaving the airport with all the luggage they checked in and that all the luggage they leave the airport with does in fact belong to them or at least was checked in associated with the ticket-holder.

It is further an object of this invention to provide means for logging and later retrieving information on which pieces of luggage where taken from the airport. Airport facilities and carriers will therefore have a record of all luggage picked up. This will assist all parties in any insurance claims for lost or delayed luggage.

Other objects and features of the invention will become evident from the description.

### BRIEF DESCRIPTION OF THE DRAWINGS

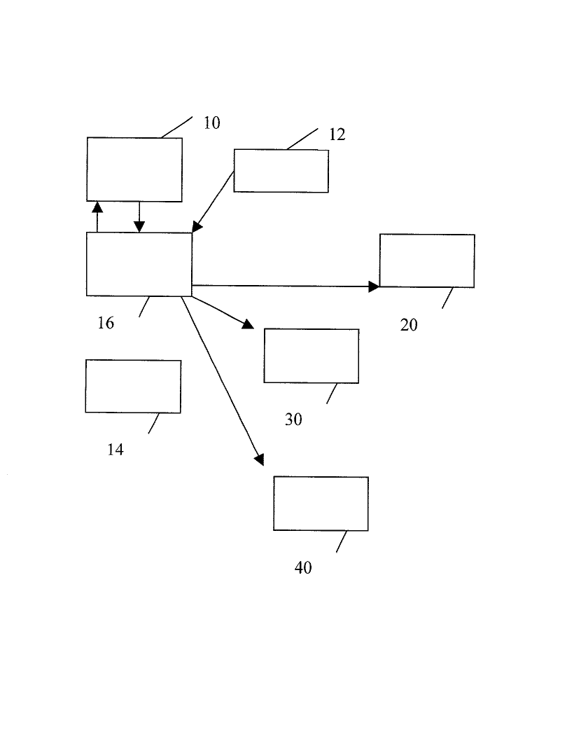

Reference is made to the following figures where FIG. 1 is a block diagram of the luggage matching device.

### DETAILED DESCRIPTION OF EMBODIMENTS OF THE INVENTION

The present invention is a hand-held device for electronic luggage matching. The luggage match device comprises a bar-code reader (12), memory (10), logic circuitry (16), a battery (14), numeric outputs (20), an optional buzzer (30), and an optional green light (40).

The device is operated as follows:

Operator resets the device by scanning a RESET tag or by pressing a reset button.

Operator scans one or more luggage tags and the A counter automatically increments.

Operator scans one or more luggage ticket stubs and the B counter automatically increments.

If the stub matches any of the luggage tags scanned, automatically, the corresponding tag is marked as being matched and the A and B counters decrement.

When both A and B counters reach zero, a green light goes on to indicate that no unmatched luggage tags remain.

At any time, the LED numeric outputs show the value of the A counter, which corresponds to the number of luggage tags, and the value of the B counter which corresponds to the number of ticket stubs.

A set stored in memory (set C) holds the luggage identification data for the matched pieces.

In a preferred embodiment, a Palms) Pilot device or similar PDA device is programmed to receive input from its serial port attached to a barcode scanner. The PDA device is programmed with software to track the scanned luggage tags and to compare said set of scanned luggage tags to a set of scanned passenger stubs. The PDA device can be docked to a central station to transfer the log of scanned luggage and passenger tags. The log can be transferred to software integrated with a particular airline's systems or with the airport's systems. From that point on, there are many uses for the information which can be made available online through the Internet as well.

In one embodiment of the software embedded in the match verification device, the following algorithm can be used.

Read Data

1. Read data

2. Luggage data?

3. If yes, goto 5

4. If no, goto 7

5. Add luggage data to set A in memory with no duplicates

6. Go back to 1

7. Ticket stub?

8. Add ticket stub data to set B in memory with no duplicates

9. Go backto 1

Update Display

1. Always show the number of elements in set A in numeric output A

2. Always show the number of elements in set B in numeric output B

Match Detection

1. Each time a new luggage tag data is scanned, check the value against all values in the ticket stub set (set B)

2. Each time a new ticket stub data is scanned, check the value against all values in the luggage stub set (set A)

3. If a match is found, remove the luggage identification data from set A and set B and put the luggage identification data into the matched set (set C)

The described algorithm is for illustrative purposes. Countless other algorithms can be developed to achieve the same result and an exhaustive description would not be possible. Claims for such algorithms would similarly be impossible to construct.

For example, another embodiment of the present invention, would be to have a device in one of two modes: Scan Mode and Match Mode. When in Scan Mode, the device expects to read in luggage tags only or passenger tags only. When in Match Mode, the device expects to read in the other set of tags. When in Match Mode, the device checks off each matched tag as the matching tag is detected. A count of unmatched tags can be shown. The actual ID of unmatched tags can be shown. A list of all tags scanned can be shown in one column and the list of all passenger tags scanned can be shown in a second column. Matched tags can be highlighted. In any of a number of arrangements known to those skilled in the art of software development, an interface can be made to show the tags detected and the tags matched and unmatched. The final result is to have a set of matched tags in memory as a record of matched passengers and luggage and to facilitate controlled luggage pickup in an efficient way with audible or visible indicators for when a passenger has taken luggage that does not belong to that passenger.

What is claimed are:

1. A luggage matching device comprising means for reading luggage identification information associated with at least one piece of luggage, means for storing said luggage identification, means for reading a passenger receipt with luggage identification information, and logic circuitry to generate match and mismatch data.

2. A device as in claim 1 further with match indication means and mismatch indication means.

3. A luggage matching device as in claim 1, wherein said luggage identification information associated with one piece of luggage is encoded using a bar-code and said means for reading said luggage identification is a bar-code reader.

4. A device as in claim 1 wherein, match and mismatch data are stored in memory of said device.

5. A device as in claim 1 with means for transmitting said match and mismatch data to a second memory device.

6. A device as in claim 4 wherein said second memory device is a computer with means for generating luggage pick-up reports whereby an airline can verify that a particular piece of luggage was or was not picked up by a particular passenger and optionally with time information of when said piece of luggage was picked up.

7. A device as in claim 1 wherein said means for reading luggage identification information is a barcode reader.
